(19) United States
(12) Patent Application Publication
(10) Pub. No.: US 2019/0180356 A1
(43) Pub. Date: Jun. 13, 2019

(54) METHOD AND SYSTEM FOR SHARING PRODUCTS

(71) Applicant: MASTERCARD INTERNATIONAL INCORPORATED, Purchase, NY (US)

(72) Inventors: Harsh PIPARSANIYA, Pune (IN); Sudhir GUPTA, Pune (IN); Rahul AGRAWAL, Pune (IN)

(21) Appl. No.: 16/209,658

(22) Filed: Dec. 4, 2018

(30) Foreign Application Priority Data
Dec. 12, 2017 (SG) 10201710340X

(51) Int. Cl. G06Q 30/06

(52) U.S. Cl. CPC G06Q 30/0645; G06Q 30/0619

(57) ABSTRACT

A method of sharing of a product among a plurality of users includes receiving a first request, by a server, for accessing a merchant website from a first user. The first user accesses the merchant website to select a first product for sharing. The first user submits one or more product sharing parameters for sharing the first product to the server. The server receives a second request for accessing the merchant web site from a second user. The second user accesses the merchant web site to purchase the first product. The second user selects the first user to share the first product with, on time-shared basis. The server charges the first and second users the first offer amount and a purchase amount, respectively, to enable sharing of the first product between the first and second users.

### FIELD OF THE INVENTION

The present invention relates generally to resource management, and more particularly, to a method for facilitating sharing of products purchased online.

### BACKGROUND

With proliferation of the internet, electronic commerce (e-commerce) websites have revolutionized the way customers shop for products. E-commerce has further been ingrained into contemporary shopping culture and has become a major retail channel for small as well as big retailers after the introduction of smartphones that provide continuous connectivity to the internet. These e-commerce websites allow the customers to go through a wide catalog of products and select those products at the best available price. The e-commerce websites have given customers the luxury of purchasing products of their choice without having to actually visit brick and mortar stores. Apart from minimizing physical efforts, the e-commerce websites have also minimized time that the customers have to spend on shopping. The e-commerce websites further offer a wide array of payment options, such as net-banking, credit and debit cards, cash-on-delivery, and the like, for purchasing the products.

Many products that are purchased by the customers have reduced usability to the customer after use. The customers have to either sell off the product to another buyer at a reduced price, or rent the product. The customers usually struggle to find prospective buyers for the product, when it is no longer needed. This causes inconvenience to the customers as delay in finding the prospective buyers may lead to further depreciation in the price of the product. Generally, the customers rent or sell the product by means of renting or second hand seller websites and mobile applications that provide services to rent or sell the products to prospective buyers. The customers may charge a high rate for selling or renting the products to the prospective buyers. Further, the prospective buyers typically have no guarantee of the quality of the products. When a product is rented, the customer has no way of assuring that the prospective buyer returns the product undamaged. This is disadvantageous and can cause monetary loss to both the customers and the prospective buyers.

In certain scenarios, a customer may find a product, which is listed for sale on an e-commerce website, unaffordable. In such scenarios, the customer may be ready to share the price of the product with other customers, who are interested in buying or renting the same product, at the time of purchase. However, these e-commerce websites offer no solution to the customer for sharing the price of the product with other customers at the time of purchase. Hence, the customer has to either wait for a sale to purchase the product on a discounted price or purchase the product at the retail price and rent or sell it after using, which is very inconvenient for the customer.

In light of the foregoing, there exists a need for a technical solution that facilitates sharing of products that are purchased online, such that the customers do not have to pay full price of the products at the time of purchase, and are ensured of a guarantee for the products.

### BRIEF SUMMARY

In an embodiment of the present invention, a method for facilitating sharing of a product among a plurality of users is shown. A server, such as a payment network server or a merchant server, receives a first request for accessing a merchant website from a first computing device of a first user. The first user accesses the merchant website to select a first product for sharing. The server further receives one or more product sharing parameters submitted by the first user. The one or more product sharing parameters include a first offer amount, and one or more time parameters for sharing the first product. The server receives a second request for accessing the merchant website from a second computing device of a second user. The second user accesses the merchant website to purchase the first product. The second user selects the first user to share the first product on time-shared basis. The server charges the first and second users the first offer amount and a purchase amount, respectively, to enable sharing of the first product between the first and second users, when the first user confirms the selection performed by the second user.

In another embodiment of the present invention, a system for sharing a product among a plurality of users, is provided. The system includes a memory and a processor that communicates with the memory. Examples of the system include a payment network server or a merchant server. The processor receives a first request for accessing a merchant website from a first computing device of a first user. The first user accesses the merchant website to select a first product for sharing. The processor receives one or more product sharing parameters submitted by the first user. The one or more product sharing parameters include a first offer amount, and one or more time parameters for sharing the first product. The processor further receives a second request for accessing the merchant website from a second computing device of a second user. The second user accesses the merchant website to purchase the first product. The second user selects the first user to share the first product on time-shared basis. The processor charges the first and second users the first offer amount and a purchase amount, respectively, to enable sharing of the first product between the first and second users, when the first user confirms the selection performed by the second user.

In yet another embodiment of the present invention, a method for facilitating sharing of a product among a plurality of users is shown. A payment network server receives a first request for accessing a merchant website from a first mobile application that is installed on a first computing device of a first user. The first user accesses the merchant website to select a first product for sharing. The payment network server further receives one or more product sharing parameters submitted by the first user. The one or more product sharing parameters include a first offer amount, and one or more time parameters for sharing the first product. The payment network server receives a second request for accessing the merchant website from a second mobile application installed on a second computing device of a second user. The second user accesses the merchant website to purchase the first product. The second user selects the first user to share the first product on time-shared basis. The payment network server charges the first and second users the first offer amount and a purchase amount, respectively, to enable sharing of the first product between the first and second users, when the first user confirms the selection performed by the second user.

In yet another embodiment of the present invention, a method for facilitating sharing of a product among a plurality of users is shown. A merchant server receives a product search request from a first computing device of a first user to search for a first product on a merchant website. The merchant server presents a graphical user interface (GUI) of the merchant website on the first computing device based on the product search request. The GUI displays the first product and one or more options associated with the first product. The one or more options include a first option and a second option. The first option offers the first user to share the first product with at least one second user. The second option offers the first user to purchase the first product for sharing with at least one second user. The merchant server receives information pertaining to a selection of one of the one or more options from the first computing device. The first user performs the selection. The merchant server charges one of an offer amount and a purchase amount to the first user for the first product, based on the selection performed by the first user.

### BRIEF DESCRIPTION OF THE DRAWINGS

The accompanying drawings illustrate various embodiments of systems, methods, and other aspects of the invention. It will be apparent to a person skilled in the art that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa.

Various embodiments of the present invention are illustrated by way of example, and not limited by the appended figures, in which like references indicate similar elements, and in which:

FIG. 1 is a block diagram that illustrates a communication environment for sharing a product among a plurality of users, in accordance with an embodiment of the present invention;

FIG. 2 is a block diagram that illustrates a payment network server of the communication environment of FIG. 1, in accordance with an embodiment of the present invention;

FIG. 3 is a block diagram that illustrates a graphical user interface (GUI) presented by a mobile application of the communication environment of FIG. 1, in accordance with an embodiment of the present invention;

FIG. 4 is a process flow diagram that illustrates a method of selection of the product by a user for sharing, in accordance with an embodiment of the present invention;

FIG. 5 is a process flow diagram that illustrates a method for purchasing and sharing the product among the plurality of users, in accordance with an embodiment of the present invention;

FIG. 6 is a high-level flow chart that illustrates the method for selection of the product by the user for sharing, in accordance with an embodiment of the present invention;

FIG. 7 is a high-level flow chart that illustrates the method for sharing the product among the plurality of users, in accordance with an embodiment of the present invention;

FIG. 8 is a flow chart that illustrates the method for sharing the product among the plurality of users, in accordance with another embodiment of the present invention;

FIG. 9 is a flow chart that illustrates the method for sharing the product among the plurality of users, in accordance with another embodiment of the present invention;

FIG. 10 is a flow chart that illustrates the method for sharing the product among the plurality of users, in accordance with another embodiment of the present invention;

FIG. 11 is a flow chart that illustrates the method for sharing the product among the plurality of users, in accordance with another embodiment of the present invention;

FIG. 12 is a flow chart that illustrates the method for sharing the product among the plurality of users, in accordance with another embodiment of the present invention;

FIG. 13 is a block diagram that illustrates a product sharing life-cycle for sharing the product among the plurality of users, in accordance with an embodiment of the present invention; and

FIG. 14 is a block diagram that illustrates system architecture of a computer system, in accordance with an embodiment of the present invention.

Further areas of applicability of the present invention will become apparent from the detailed description provided hereinafter. It should be understood that the detailed description of exemplary embodiments is intended for illustration purposes only and is, therefore, not intended to necessarily limit the scope of the present invention.

### DETAILED DESCRIPTION

The present invention is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. In one example, the teachings presented and the needs of a particular application may yield multiple alternate and suitable approaches to implement the functionality of any detail described herein. Therefore, any approach may extend beyond the particular implementation choices in the following embodiments that are described and shown.

References to “an embodiment”, “another embodiment”, “yet another embodiment”, “one example”, “another example”, “yet another example”, “for example” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

### Overview

Various embodiments of the present invention provide a method and a system for facilitating sharing of a product, which is listed for sale on a merchant website, between first and second users. A first mobile application is installed on a first user-computing device of a first user. The first user submits a first request for accessing a merchant website by way of the first mobile application. The first user-computing device then transmits the first request to a server. Examples of the server include a payment network server or a merchant server. The server re-directs a browser or the first mobile application on the first user-computing device to the merchant website. The first user selects a first product for sharing on a time-shared basis. The merchant website transmits product information of the first product to the server. The product information may include details of the first product, such as unique product identification number, a product name, a retail price, a manufacturing date, a batch number, a manufacturing location, guarantee and warranty periods, an expected product lifetime, and the like. The server further transmits a first notification to the first user to provide product sharing parameters. The product sharing parameters may include an offer amount, a payment mode; such as e-banking, e-wallet, credit or debit cards, and one or more time parameters; such as a start date, an end date, and a product usage duration. The first user submits the product sharing parameters to the first mobile application and the server receives the product sharing parameters. The server further transmits a second notification to an issuer server to block the offer amount from a first payment account of the first user.

The second user submits a second request for accessing the merchant website by way of a second mobile application installed on a second user-computing device of the second user. The second user-computing device then transmits the second request to the server. The server re-directs a browser or the second mobile application on the second user-computing device to the merchant website. The second user selects the first product for purchasing and sharing with the first user on a time-shared basis. The merchant website further transmits the product information of the first product to the server. The server further transmits a third notification to the second user for defining a product sharing life-cycle for the first product. The second user defines the product sharing life-cycle and communicates it to the server. The server further transmits a third request to the first user-computing device for confirming the product sharing life-cycle. The first user confirms the product sharing life-cycle, and communicates the confirmation to the server. Based on the product sharing life-cycle confirmation received from the first user, the server charges the offer amount and a purchase amount to the first and second users, respectively. The server further transmits a fourth request to the issuer server to deduct the offer amount and a purchase amount from the first payment account and a second payment account, respectively. The second user is an account holder of the second payment account. Further, the purchase amount is an amount that the second user pays for purchasing the product and is also less than a retail price of the first product. In one embodiment, the server determines the purchase amount for the second user by deducting the offer amount from the retail price of the first product. The issuer server further credits the offer amount and the purchase amount to a merchant account associated with the merchant website.

Thus, the method and the system, in accordance with various embodiments of the present invention, facilitate sharing of the first product between the first and second users, and also ensure that the quality of the product is maintained, while the first product is shared between the first and second users. The method and the system further enable the first and second users to use the product for a desired time period, while paying a price less than a retail price of the product.

### Terms Description (in Addition to Plain and Dictionary Meaning)

Server is a physical or cloud data processing system on which a server program runs. A server may be implemented in hardware or software, or a combination thereof. In one embodiment, the server is implemented as a computer program that is executed on programmable computers, such as personal computers, laptops, or a network of computer systems. The server may correspond to a merchant server, a digital wallet server, an acquirer server, a payment network server, or an issuer server.

Merchant is an entity that offers various products and/or services in exchange of payments. The merchant may establish a merchant account with a financial institution, such as a bank (hereinafter “acquirer bank”) to accept the payments from several users.

Issuer bank is a financial institution, such as a bank, where accounts of several users are established and maintained. The issuer bank ensures payment for authorized transactions in accordance with various payment network regulations and local legislation.

Payment networks are transaction card associations that act as intermediate entities between acquirer banks and issuer banks to authorize and fund transactions. Examples of various payment networks include MasterCard®, American Express®, VISA®, Discover®, Diners Club®, and the like. Payment networks settle transactions between various acquirer banks and issuer banks when transaction cards are used for initiating the transactions. The payment network ensures that a transaction card used by a user for initiating a transaction is authorized.

Mobile application is a software application that is installed on a computing device of a user. Mobile applications are virtual gateways that connect to various servers for facilitating interaction of the user thereto. The mobile application may be implemented by way of a code or a program stored in memory of the computing device. In one embodiment, a mobile application may enable a user to avail various facilities or purchase various products that are offered by a merchant. The mobile application may further present a graphical user interface (GUI) on a display of the computing device, which enables the user to select one or more options associated with purchasing the product. The mobile application may further initiate a transaction from a payment account of the user, when the user selects a product from a merchant website.

Merchant website is an e-commerce website that offers a user a catalogue of products and/or services to be used. The merchant website is hosted on a merchant server, and may be accessed by a user from a mobile application or by way of an internet browser. The merchant website may be built using programming languages such as Hypertext Markup Language® (HTML), Cascading Style Sheets® (CSS), Javascript® (JS), and the like. The merchant website may be an e-commerce website such as Amazon®, Costco®, Zappos®, eBay®, and the like.

Sharing a product on time-shared basis is a method of product sharing among multiple users, where the multiple users use a product one after the other for fixed time durations. A product sharing life-cycle defines a time-duration for each of the multiple users for which he or she can use the product. For example, based on the product sharing life-cycle of a first product, a first user can use the first product from Apr. 25, 2017 to May 10, 2017 and a second user can use the first product from May 11, 2017 to May 20, 2017 after the first user. In one embodiment, the product sharing life-cycle may be defined by an owner of the product. In another embodiment, the product sharing life-cycle may be automatically generated by a server based on product sharing parameters provided by the multiple users.

Product sharing parameters are parameters that a user provides for sharing a product with multiple users. The product sharing parameters may include one or more time parameters, an offer amount, a payment mode, such as e-banking, e-wallet, credit or debit cards, and the like. The one or more time parameters may further include, but are not limited to, a start date, an end date, and product usage duration. The start date and the end date indicate the dates between which the user wants to use the product. The product usage duration represents a time duration for which the user wants to use the product. The offer amount represents a price that the user is ready to pay for using the product from the start date to the end date.

Product information includes details of a product that a user wants to purchase or share. Product information may include, but is not limited to, a unique product identification number, a product name, a retail price, a manufacturing date, a batch number, a manufacturing location, guarantee and warranty periods, an expected product lifetime, and the like. The user may decide whether to purchase the product or not based on the product information.

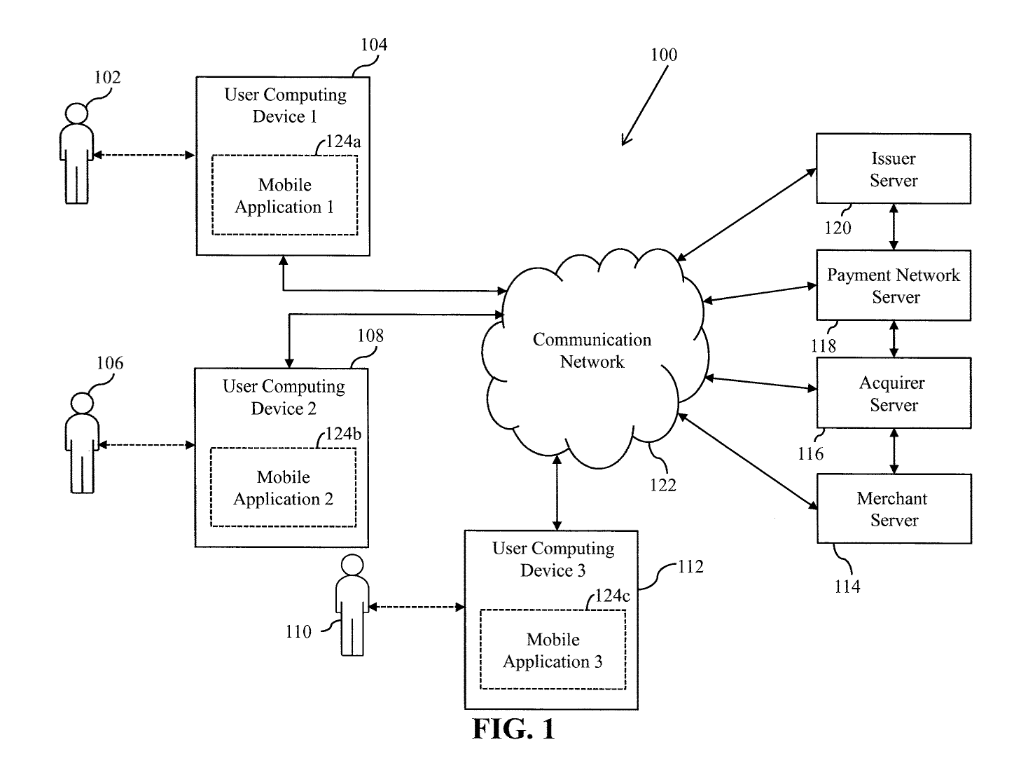

Referring now to FIG. 1, a block diagram that illustrates a communication environment 100 for sharing a product among a plurality of users, in accordance with an embodiment of the present invention, is shown. The communication environment 100 includes a first user 102 in possession of a first user-computing device 104, a second user 106 in possession of a second user-computing device 108, and a third user 110 in possession of a third user-computing device 112. The communication environment 100 further includes a merchant server 114, an acquirer server 116, a payment network server 118, and an issuer server 120. The first through third user-computing devices 104, 108, and 112 communicate with the merchant server 114, the acquirer server 116, the payment network server 118, and the issuer server 120 by way of a communication network 122.

The first through third users 102, 106, and 110 are individuals who select a product, listed for sale on an e-commerce website, for using or purchasing on shared-basis. The first through third users 102, 106, and 110 may initiate financial transactions from first through third payment accounts, respectively, to purchase or share the product. The first through third users 102, 106, and 110 may use various payment modes, such as e-banking, e-wallets, a transaction card, and the like, for initiating the financial transactions. The first through third users 102, 106, and 110 may be account holders of the first through third payment accounts, respectively. In one example, the first through third payment accounts are maintained by a financial institution, such as an issuer bank. The issuer bank may have issued first through third transaction cards (hereinafter referred to as “transaction cards”) to the first through third users 102, 106, and 110, respectively that are linked to the first through third payment accounts, respectively. Examples of the transaction cards include credit cards, debit cards, membership cards, promotional cards, charge cards, prepaid cards, gift cards, and the like. In one embodiment, the transaction cards may be physical cards. In another embodiment, the transaction cards may be virtual cards or payment tokens that are stored electronically in memories (not shown) of the first through third user-computing devices 104, 108, and 112, respectively. Each of the first through third transaction cards includes identification information (hereinafter “first through third account identification information) of the corresponding payment account. The first account identification information may include a first account number, a first unique card number, a first expiry date, name of the first user 102, and the like. The second account identification information may include a second account number, a second unique card number, a second expiry date, name of the second user 106, and the like. The third account identification information may include a third account number, a third unique card number, a third expiry date, name of the third user 110, and the like.

The first through third user-computing devices 104, 108, and 112 are communication devices, which belong to the first through third users 102, 106, and 110, respectively. Various mobile applications, such as first through third mobile applications 124a-124c, may be installed on the first through third user-computing devices 104, 108, and 112, respectively. The first through third users 102, 106, and 110 may login to the first through third mobile applications 124a-124c, respectively, by using corresponding login details. Login details of each of the first through third users 102, 106, and 110 may include a unique login ID and a login password. In one embodiment, the first through third users 102, 106, and 110 may use the first through third mobile applications 124a-124c, respectively, to purchase or share the product. In one embodiment, the first user-computing device 104 may be associated with first registered contact information linked to the first payment account and the second user-computing device 108 may be associated with second registered contact information linked to the second payment account. Similarly, the third user-computing device 112 may be associated with third registered contact information linked to the third payment account. The first registered contact information may include a first registered contact number, such as a mobile telephone number, and a first registered email address of the first user 102. The first user 102 may have registered the first contact number and the first email address at the time of setting up the first payment account with the issuer bank. It will be apparent to a person skilled in the art that the second and third registered contact information include second and third registered email addresses, and second and third registered contact numbers of the second and third users 106 and 110, respectively. Examples of the first through third user-computing devices 104, 108, and 112 include, but are not limited to, a mobile phone, a smartphone, a personal digital assistant (PDA), a tablet, a phablet, a laptop, or any other portable communication device.

The merchant server 114 is a computing server that is associated with a merchant (not shown). The merchant may establish a merchant account with a financial institution, such as an acquirer bank, to accept the payments for products and/or services. For example, the merchant server 114 may accept the payments for products and/or services via an online payment gateway or the first through third mobile applications 124a-124c used by the first through third users 102, 106, and 110, respectively. The merchant server 114 may further host a merchant website that provides a catalogue of products that are for sale. The merchant website may be an e-commerce website such as Amazon, Costco, Zappos, eBay, and the like.

The acquirer server 116 is a computing server that is associated with the acquirer bank. The acquirer server 116 receives transaction details of various transactions, initiated by the first through third users 102, 106, and 110, from the merchant server 114 or the first through third mobile applications 124a-124c, respectively. The transaction details of a transaction may include a transaction amount, a transaction identification number, time and date of the transaction, a card type, account identification information of a payment account from which the transaction is initiated, and the like.

The payment network server 118 is a computing server that is associated with a payment network of a transaction card. In one embodiment, the payment network server 118 may enable the first through third users 102, 106, and 110 to access various merchant websites for availing the services and/or products offered by the merchant websites. The payment network server 118 may further facilitate sharing of the products offered by the merchant websites among the first through third users 102, 106, and 110, based on various requests submitted by the first through third users 102, 106, and 110. The first through third users 102, 106, and 110 may submit the requests by using the first through third mobile applications 124a-124c. The payment network server 118 may further receive the transaction details of various transactions, initiated by the first through third users 102, 106, and 110, from the merchant server 114, the acquirer server 116, or the first through third mobile applications 124a-124c. The payment network server 118 further charges the first through third users 102, 106, and 110 a corresponding amount for availing the services and/or the products, and further requests the issuer server 120 to deduct the corresponding amount from the first through third payment accounts of the first, through third users 102, 106, and 110, respectively, based on the corresponding transaction details. Examples of the payment networks include MasterCard, American Express, VISA, Discover, Diners Club, and the like.

The issuer server 120 is a computing server that is associated with the issuer bank. The issuer bank is a financial institution that manages accounts of multiple account holders. Account details of the accounts established with the issuer bank are stored in a memory (not shown) or a database (not shown) of the issuer server 120 or on a cloud server (not shown) associated with the issuer bank. The account details of an account established with the issuer bank may include an account balance, credit line details, details of the account holder, transaction history of the account holder, account identification information, and the like. The details of the account holder may include name, age, gender, physical attributes, registered contact number, registered email address, and the like, of the account holder.

Examples of the merchant server 114, the acquirer server 116, the payment network server 118, and the issuer server 120 include, but are not limited to, a computer, a laptop, a mini computer, a mainframe computer, any non-transient and tangible machine that can execute a machine-readable code, or a network of computer systems.

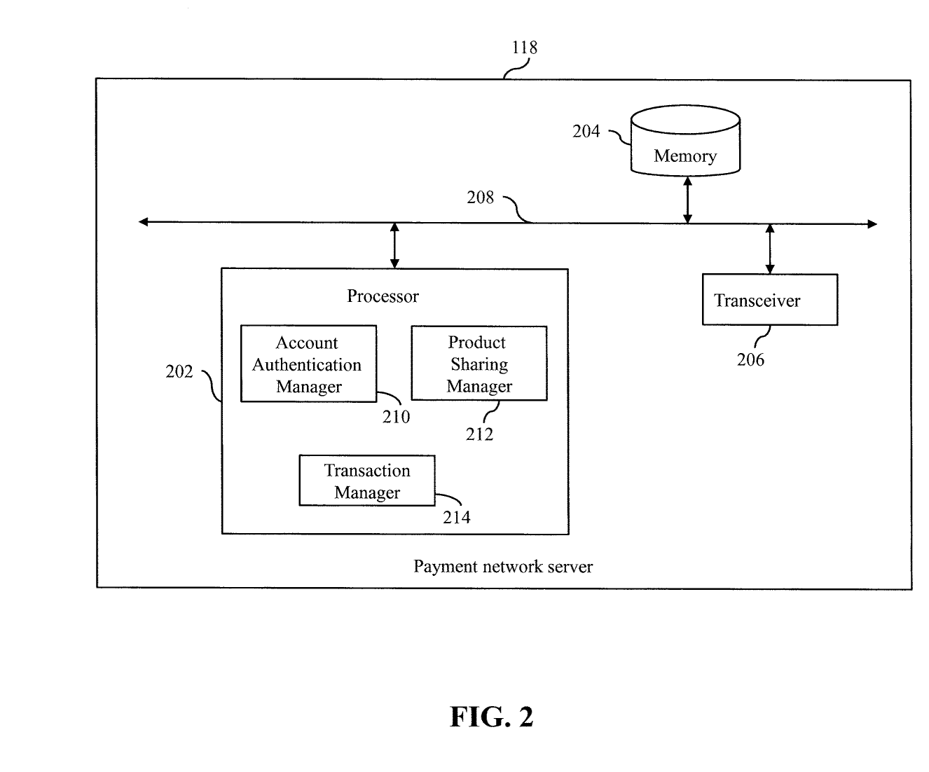

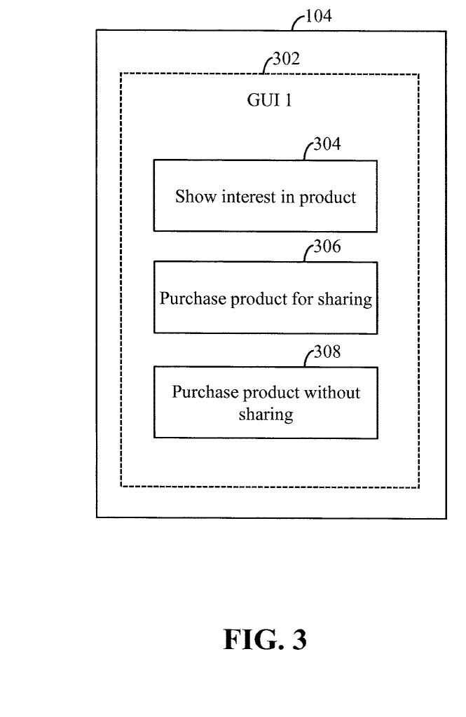

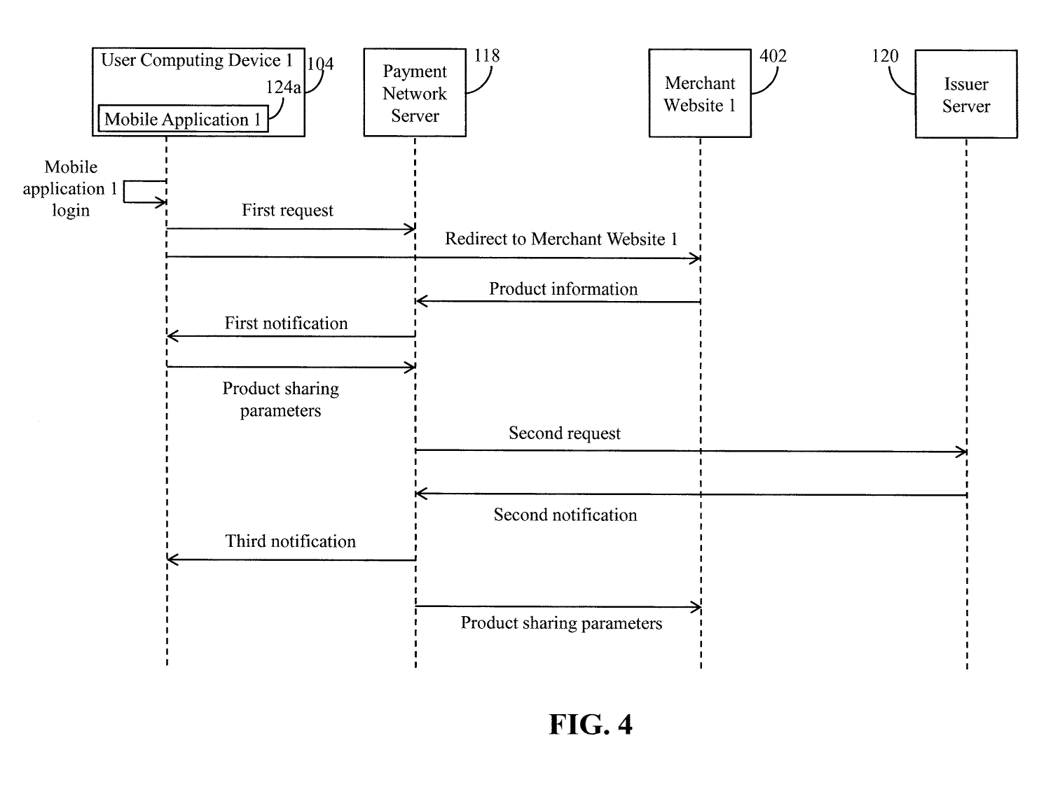

The communication network 122 is a medium through which content and messages are transmitted between various devices, such as the first through third user-computing devices 104, 108, and 112, the merchant server 114, the acquirer server 116, the payment network server 118, and the issuer server 120. Examples of the communication network 122 include, but are not limited to, a Wi-Fi network, a light fidelity (Li-Fi) network, a local area network (LAN), a wide area network (WAN), a metropolitan area network (MAN), a satellite network, the internet, a fiber optic network, a coaxial cable network, an infrared network, a radio frequency (RF) network, or any combination thereof. Various devices in the communication environment 100 may connect to the communication network 122 in accordance with various wired and wireless communication protocols, such as Transmission Control Protocol and Internet Protocol (TCP/IP), User Datagram Protocol (UDP), 2^{nd} Generation (2G), 3^{rd} Generation (3G), 4^{th} Generation (4G), long term evolution (LTE) communication protocols, or any combination thereof. The functioning of the elements of the communication environment 100 is explained in conjunction with FIG. 2, FIG. 3, and FIG. 4.

Referring now to FIG. 2, a block diagram that illustrates the payment network server 118 of FIG. 1, in accordance with an embodiment of the present invention, is shown. The payment network server 118 includes a processor 202, a memory 204, and a transceiver 206 that communicate with each other via a bus 208. The processor 202 includes an account authentication manager 210, a product sharing manager 212, and a transaction manager 214. It will be apparent to a person skilled in the art that the merchant server 114 may also be implemented by the block diagram of FIG. 2, without deviating from the scope of the invention.

The processor 202 includes suitable logic, circuitry, and/or interfaces to execute operations related to sharing or purchasing of products and handling of various requests that are received from one or more entities, such as the first through third mobile applications 124a-124c, the merchant server 114, the acquirer server 116, or the payment network server 118. Examples of the processor 202 include, but are not limited to, an application-specific integrated circuit (ASIC) processor, a reduced instruction set computing (RISC) processor, a complex instruction set computing (CISC) processor, a field-programmable gate array (FPGA), and the like. The processor 202 executes the operations related to sharing or purchasing of the various products by way of the account authentication manager 210, the product sharing manager 212, and the transaction manager 214.

The memory 204 includes suitable logic, circuitry, and/or interfaces to store user profiles of multiple users. A user profile of a user may include registered contact information, login details, and account identification information of the user. For example, the user profile of the first user 102 includes the first registered contact information, login details of the first user 102, and the first account identification information. The memory 204 further includes a set of computer readable instructions for hosting the first through third mobile applications 124a-124c on the payment network server 118. Examples of the memory 204 include random access memory (RAM), read-only memory (ROM), a removable storage drive, a hard disk drive (HDD), and the like.

The transceiver 206 transmits and receives data over the communication network 122 via one or more communication network protocols. The transceiver 206 transmits/receives various requests and notifications related to sharing or purchasing of the products to/from at least one of the first through third user-computing devices 104, 108, and 112, the first through third mobile applications 124a-124c, and the merchant server 114. Examples of the transceiver 206 include, but are not limited to, an antenna, a radio frequency transceiver, a wireless transceiver, a Bluetooth transceiver, an ethernet port, a universal serial bus (USB) port, or any other device configured to transmit and receive data.

The account authentication manager 210 includes suitable logic and/or interfaces for authenticating the first through third users 102, 106, and 110, when the first through third users 102, 106, and 110 access the first through third mobile applications 124a-124c, respectively. For example, when the first user 102 logins to the first mobile application 124a by entering the corresponding login details, the account authentication manager 210 compares the login details entered by the first user 102 with the login details included in the user profile of the first user 102 stored in the memory 204. In a scenario, if the account authentication manager 210 determines that the login details entered by the first user 102 match the login details included in the user profile of the first user 102, the first user 102 is granted access to the first mobile application 124a. In an alternate scenario, if the account authentication manager 210 determines that the login details entered by the first user 102 do not match the login details included in the user profile of the first user 102, the first user 102 is denied access to the first mobile application 124a. The account authentication manager 210 may further prompt the first user 102 to create an account in the first mobile application 124a.

The account authentication manager 210 further verifies the account identification information provided by a user, such as the first through third users 102, 106, and 110, for performing a transaction. For example, the first user 102 may provide the first account identification information for performing a transaction from the first payment account to purchase a product. The account authentication manager 210 receives the transaction details and compares the first account identification information provided by the first user 102 with the account identification information included in the user profile of the first user 102 that is stored in memory 204, for verification.

The product sharing manager 212 includes suitable logic and/or interfaces for managing requests and notifications received from one or more of the first through third mobile applications 124a-124c, the first through third user-computing devices 104, 108, and 112, and the merchant server 114 for facilitating the sharing or purchasing of the products offered on the merchant websites.

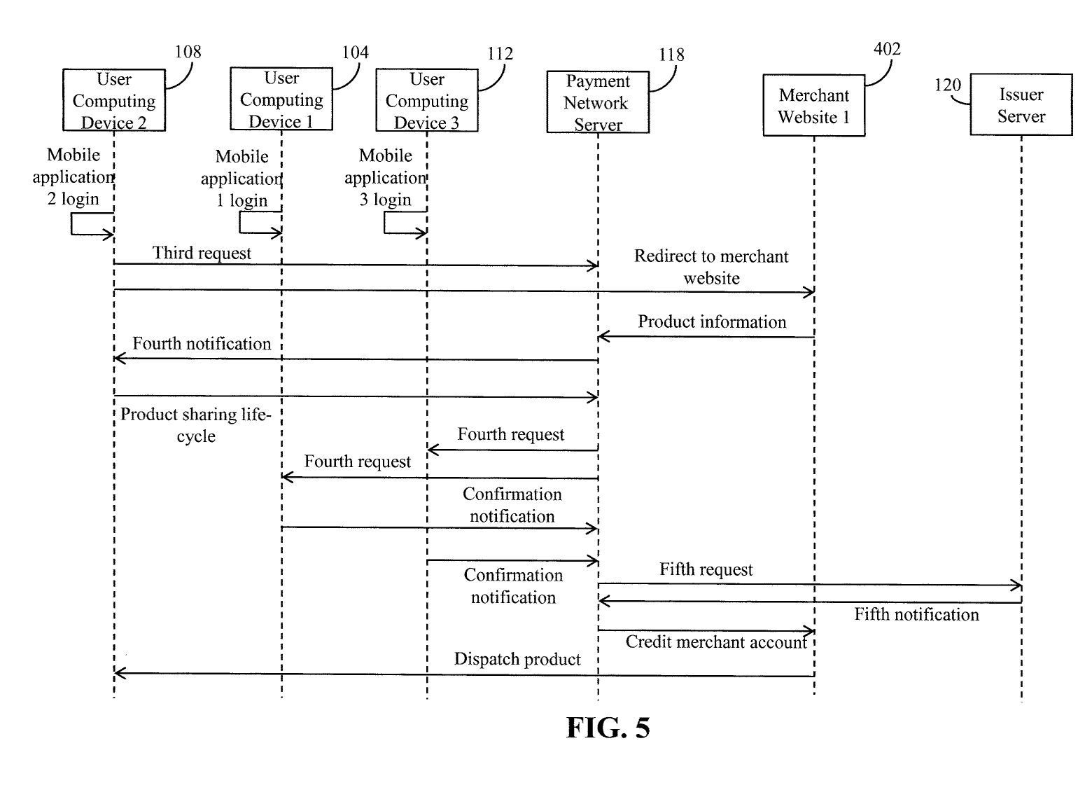

The transaction manager 214 includes suitable logic and/or interfaces for authorizing transactions, based on the verification of the account identification information associated with each transaction. For example, if there is a match between the first account identification information provided by the first user 102 and the account identification information included in the user profile of the first user 102, the transaction manager 214 authorizes the transaction, else the transaction is not authorized. The transaction manager 214 may further request the issuer server 120 to deduct a transaction amount associated with each transaction from the corresponding payment account, when the transaction is authorized. The functions performed by the payment network server 118 for facilitating the purchasing and sharing of a product among the first through third users 102, 106, and 110 are explained in conjunction with FIG. 4 and FIG. 5.

Referring now to FIG. 3, a first graphical user interface (GUI) 302 presented by a mobile application, such as the first through third mobile applications 124a, 124b, and 124c, on a display of a user-computing device, such as the first through third user-computing devices 104, 108, and 112, in accordance with an embodiment of the present invention, is shown. For sake of simplicity, the first GUI 302 is explained in conjunction with the first user-computing device 104.

The first GUI 302 allows the first user 102 to interact with the first mobile application 124a. The first GUI 302 may be designed using a GUI builder software such as Atmel Qtouch®, Altia Design®, GrabCAD®, and the like. It will be apparent to a person skilled in the art that the second and third mobile applications 124b and 124c may also present first GUI 302 on displays of the second and third user-computing devices 108 and 112, respectively.

The first GUI 302 presents a “Show interest in product” option 304, a “Purchase product for sharing” option 306, and a “Purchase product without sharing” option 308. In one embodiment, the first user 102 may want to use a product without purchasing it. In this scenario, the first user 102 may select the “Show interest in product” option 304 for using the product on shared-basis without actually purchasing the product. In another embodiment, the first user 102 may want to purchase the product and use it on a shared-basis with one or more other users, such as the second and/or third users 106 and 110. In this scenario, the first user 102 may select the “Purchase product for sharing” option 306 for purchasing the product and sharing it with on one or more other users, such as the second and/or third users 106 and 110 on a time-shared basis. In yet another embodiment, the first user 102 may want to purchase the product without sharing with any other user. In this scenario, the first user 102 may select the “Purchase product without sharing” option 308 for purchasing the product without sharing it with any other user. The first user 102 may select any one of the options 304, 306, and 308 by providing a user input, such as a voice input, a touch-based input, or a keypad based input, and the like. It will be apparent to a person skilled in the art that the first GUI 302 is an exemplary GUI and should not be construed to limit the scope of the invention in any way.

Referring now to FIG. 4, a process flow diagram that illustrates a selection of a first product by the first user 102 for sharing, in accordance with an embodiment of the present invention, is shown.

The first user 102 opens the first mobile application 124a on the first user-computing device 104 and the first mobile application 124a prompts the first user 102 to submit the corresponding login details, such as a first unique login ID and a first login password. The first user 102 enters the first unique login ID and the first login password on the first mobile application 124a, and the first mobile application 124a transmits the first unique login ID and the first login password to the payment network server 118 via the communication network 122. The transceiver 206 receives the login details and the account authentication manager 210 fetches the user profile of the first user 102 from the memory 204, based on the first unique login ID. The account authentication manager 210 further compares the first login password entered by the first user 102 with the login password stored in the user profile of the first user 102. In one scenario, when the first login password entered by the first user 102 matches the login password stored in the user profile, the account authentication manager 210 grants the first user 102 an access to the first mobile application 124a and the login is successful. In alternate scenario, when the first login password does not match the login password stored in the user profile, the first user 102 is denied access to the first mobile application 124a and the login fails.

The first mobile application 124a presents the first GUI 302 on the display of the first user-computing devices 104, when the first user 102 successfully logs in to the first mobile application 124a. The first GUI 302 presents the “Show interest in product” option 304, the “Purchase product for sharing” option 306, and the “Purchase product without sharing” option 308 to the first user 102. The first user 102 may want to use a first product on a shared-basis, without purchasing the first product. Hence the first user 102 selects the “Show interest in product” option 304.

In one embodiment, the first mobile application 124a prompts the first user 102 to submit the first account identification information, when the first user 102 selects one of the options 304, 306, and 308 presented on the first GUI 302. The first user 102 submits the first account identification information to the first mobile application 124a. The first mobile application 124a further transmits the first account identification information to the payment network server 118. In one embodiment, the account authentication manager 210 compares the first account identification information against the account identification information of the multiple users stored in the memory 204. In another embodiment, the account authentication manager 210 may request the issuer server 120 to compare the first account identification information against the account identification information of the multiple users stored in the database (not shown) of the issuer server 120. If the account authentication manager 210 or the issuer server 120 finds a match for the first account identification information, the account authentication manager 210 determines that the first account identification information is verified. Else, the account authentication manager 210 determines that the first account identification information is not verified. The account authentication manager 210 may transmit a message to the first mobile application 124a to communicate the result of verification. In one embodiment, the first mobile application 124a may prompt the first user 102 to re-submit the first account identification information, if the first account identification information that was submitted in the previous attempt is not verified. In another embodiment, the first mobile application 124a may prompt the first user 102 to save the first account identification information for subsequent transactions, if the first account identification information is verified. The account authentication manager 210 may update the user profile of the first user 102 to store the verified first account identification information in the user profile. In one embodiment, the first mobile application 124a stores the verified first account identification information in the memory (not shown) of the first user-computing device 104.

In one embodiment, the first user-computing device 104 transmits a first request for accessing a first merchant website 402 to the payment network server 118, based on the selection of the option 304 by the first user 102. In another embodiment, the first mobile application 124a may present a list of merchant websites to the first user 102. The list of merchant websites may include e-commerce websites such as Amazon, Costco, eBay, Zappos, and the like. The first user 102 may select one of the merchant websites included in the list of merchants. For example, the first user 102 selects the first merchant website 402 from the list of merchant websites. The first mobile application 124a then transmits the first request that includes information pertaining to the selection of the first merchant website 402 by the first user 102 to the payment network server 118.

The product sharing manager 212 then redirects a browser of the first user-computing device 104 to the first merchant website 402. In another embodiment, the product sharing manager 212 then redirects the first mobile application 124a to present the first merchant website 402 to the first user 102.

The first merchant website 402 displays a catalogue of products that are listed for sale to the first user 102. The first user 102 browses through the catalogue of products displayed on the first merchant website 402 and selects the first product. Based on the selection of the first product by the first user 102, the first merchant website 402 transmits product information of the first product to the payment network server 118. The first product information may include, but is not limited to a unique product identification number, a product name, a retail price, a manufacturing date, a batch number, a manufacturing location, guarantee and warranty periods, an expected product lifetime, and the like. The product sharing manager 212 stores the product information in the memory 204 or a cloud server (not shown). In one embodiment, the product sharing manager 212 further stores a first list of users that have selected various products for sharing and a corresponding list of product information. Based on the product information of the first product received from the first merchant website 402, the product sharing manager 212 updates the first list of users for including the first user 102 and the product information of the first product.

The product sharing manager 212 then transmits a first notification to the first user-computing device 104 for submitting product sharing parameters for the first product. Based on the first notification, the first mobile application 124a prompts the first user 102 to submit the product sharing parameters. The product sharing parameters include a first offer amount, the first registered contact number, a first security amount, and one or more first time parameters for sharing the first product. The one or more first time parameters may include a first start date, a first end date, and a first product usage duration. The first offer amount is an amount the first user 102 is willing to pay for using the first product from the first start date to the first end date. The first offer amount is less than a retail price of the first product as the first user 102 has chosen option 304 from the first GUI 302. The first product usage duration is a time duration for which the first user 102 wants to use the first product. The first security amount is an amount that the first user 102 pays for compensating any damage that may happen to the first product during the first product usage duration. In one embodiment, the first security amount may be a difference of the retail price and the first offer amount. In another embodiment, the first security amount may be decided by the first user 102 based on the extent of the damage. In one example, the retail price of the first product may be 100 U.S. Dollars. However, the first user 102 may be willing to pay only 40 U.S. Dollars as the first offer amount for using the product from the first start date to the first end date and 60 U.S. Dollars as the first security amount. The first user 102 submits the product sharing parameters to the first mobile application 124a. The first mobile application 124a transmits the product sharing parameters to the payment network server 118 by way of the communication network 122. The product sharing manager 212 further updates the first list of users to include the product sharing parameters corresponding to the first user 102.

The transaction manager 214 transmits a second request to the issuer server 120 for blocking the first offer amount from the first payment account of the first user 102. The issuer server 120 acknowledges the second request, and blocks the first offer amount from the first payment account of the first user 102. The issuer server 120 further transmits a second notification to the payment network server 118 to indicate that the first offer amount has been blocked from the first payment account. The transaction manager 214 transmits a third notification to the first user-computing device 104 to indicate that the first offer amount has been blocked from the first payment account by the issuer bank. In an embodiment, the transaction manager 214 may transmit the third notification to the first user-computing device 104 by way of the registered contact information of the first user 102. In an embodiment, the product sharing manager 212 further transmits the product sharing parameters to the merchant server 114 of the first merchant website 402. The merchant server 114 stores the product sharing parameters in a second memory (not shown) thereof.

It will be apparent to a person skilled in the art that the second or third users 106 and 110 may also select any product, such as the first product, for sharing on a time-shared basis similar to the first user 102.

Referring now to FIG. 5, a process flow diagram that illustrates a method for purchasing and sharing the product among the plurality of users, such as the first through third users 102, 106, and 110, in accordance with an embodiment of the present invention, is shown. The first through third users 102, 106, and 110 login to the first through third mobile applications 124a-124c in a similar manner as described in FIG. 4. Further, the first through third account identification details of the first through third payment accounts of the first through third users 102, 106, and 110, respectively, are saved in the corresponding user profiles that are stored in the memory 204 in a similar manner as described in the foregoing description.

The second mobile application 124b re-directs the second user 106 to the first GUI 302. The second user 106 may want to purchase the first product on shared-basis, and hence the second user 106 selects the “Purchase product for sharing” option 306 from the first GUI 302.

In one embodiment, the second mobile application 124b transmits a third request to the payment network server 118 for accessing the first merchant website 402, based on the selection of the option 306 by the second user 106. In another embodiment, the second mobile application 124b presents the second user 106 with the list of merchant websites. The second user 106 selects the first merchant website 402 from the list of merchant websites. The second mobile application 124b then transmits the third request that includes information pertaining to the selection of the first merchant website 402 by the second user 106 to the payment network server 118. In an embodiment, the second user 106 a second merchant website (not shown) from the list of merchant websites.

The product sharing manager 212 acknowledges the third request and re-directs the second user-computing device 108 to the first merchant website 402. In an embodiment, product sharing manager 212 re-directs a browser of the second user-computing device 108 to the first merchant website 402. In another embodiment, the product sharing manager 212 re-directs the second mobile application 124b to present the first merchant website 402 to the second user 106. The first merchant website 402 displays the catalogue of products to the second user 106.

The second user 106 browses through the catalogue of products listed for sale on the first merchant website 402. The second user 106 selects the first product to be purchased at a first purchase amount and shared with various users, who have selected the first product for sharing in a similar manner as described in FIG. 4. The first purchase amount is less than the retail price of the first product as the second user 106 has chosen the option 306 from the first GUI 302. It will be apparent to a person having ordinary skill in the art that the any one of the first through third users 102, 106, and 110 may purchase the product for sharing with other users.

The first merchant website 402 transmits the product information of the first product to the payment network server 118. The product sharing manager 212 further transmits a fourth notification to the second user 106. The fourth notification includes a second list of users who have selected the first product for sharing. In an embodiment, the second list of users is a sub-set of the first list of users that is stored in the memory 204. The product sharing manager 212 may generate the second list of users by identifying the users from the first list, who have selected the first product for sharing. The product sharing manager 212 may identify the users from the first list, based on the product information included in the first list corresponding to each user. For example, the product sharing manager 212 may identify all users, such as the first and third users 102 and 106, who have selected the first product for sharing that has the unique product identification number “BAS-123”. The second list of users may further include the product sharing parameters corresponding to each user, such as the first and third users 102 and 110.

Based on the fourth notification, the second mobile application 124b prompts the second user 106 for defining a product sharing life-cycle for the first product based on the second list of users. For defining the product sharing life-cycle, the second user 106 selects one or more users (hereinafter referred to as “list of selected users”) from the second list of users to share the first product with and also specifies one or more time second time parameters for using the first product. In one embodiment, the second user 106 may select all the users included in the second list of users to share the first product with. For example, the second user 106 selects both the first and third users 102 and 110 that are included in the second list of users. In another embodiment, the second user 106 may not select all the users included in the second list of users due to various factors, such as less offer amount, or start and end dates that do not meet the second user's 106 requirement. For example, the second user 106 selects only the first user 102 from the first and third users 102 and 110 included in the second list of users to share the first product with. The second user 106 submits the product sharing life-cycle to the second mobile application 124b and the second mobile application 124b transmits the product sharing life-cycle to the product sharing manager 212. The product sharing manager 212 further updates the product sharing life-cycle by including a sequence in which the first product is used by the users in the list of selected users. The product sharing manager 212 determines the sequence in which the first through third users 102, 106, and 110 may use the first product based on the one or more time parameters specified by each of the first through third users 102, 106, and 110. For example, the second user 106 may have specified a second start date as Apr. 1, 2017 and a second end date as Apr. 15, 2017 in the one or more second time parameters. Further, the first user 102 may have specified the first start date as Apr. 15, 2017 and the first end date as Apr. 25, 2017 in the one or more first time parameters and the third user 110 may have specified a third start date as May 10, 2017 and a third end date as May 25, 2017 in one or more third time parameters. Hence, the product sharing manager 212 determines the sequence in which the second user 106 gets to use the first product in the beginning of the product sharing life-cycle followed by the first user 102 and the third user 110.

Based on the list of selected users in the product sharing life-cycle, the product sharing manager 212 transmits a fourth request to each user in the list of selected users for providing a confirmation to the selection performed by the second user 106. For example, if the list of selected users includes the first and third users 102 and 110, the product sharing manager 212 transmits the fourth request to each of the first and third users 102 and 110. The users in the list of selected users may provide the confirmation by way of a confirmation notification in response to the fourth request. The confirmation notification may indicate one of a confirmation and a rejection of the selection performed by the second user 106. The confirmation indicates that the corresponding user, such as the first or third user 102 and 110, has agreed to share the first product with the second user 106 and also accepts various terms and conditions for sharing the first product. In an embodiment, the terms and conditions for a user, such as the first or third user 102 and 110, may include description of penalty that a user has to pay in case of product damage during the use. The terms and conditions may further include details of previous users, who may be using the first product prior to the corresponding user. The rejection indicates that the corresponding user, such as the first or third user 102 and 110, has disagreed to share the first product with the second user 106. The product sharing manager 212 receives the confirmation notification from the first and third user-computing devices 104 and 112.

In one embodiment, all the users, such as the first and third users 102 and 110, in the list of selected users may provide the confirmation for sharing the first product with the second user 106. In another embodiment, one or more users, such as the first or third user 102 and 110, in the list of selected users may not provide the confirmation for sharing the first product with the second user 106. In such a scenario, the product sharing manager 212 may again transmit the fourth notification to the second user 106 for re-defining the product sharing life-cycle. The fourth notification includes an updated second list that includes the users who have provided confirmation for sharing the first product with the second user 106. The product sharing manager 212 may repeat this process until all the selected users in the product sharing life-cycle confirm to share the first product with the second user 106.

Based on the confirmation provided by all the users, such as the first and third users 102 and 110, in the selected list of users, the transaction manager 214 charges the first offer amount, the first purchase amount, and a third offer amount to first through third users 102, 106, and 110, respectively. The transaction manager 214 further transmits a fifth request to the issuer server 120 for debiting the first offer amount, the first purchase amount, and the third offer amount from the first through third payment accounts of the first through third users 102, 106, and 110, respectively. The transaction manager 214 further instructs the issuer server 120 to block first through third security amounts from the first through third payment accounts of the first through third users 102, 106, and 110, respectively, based on the fifth request. In an embodiment, the first security amount is a first difference between the retail price of the first product and the first offer amount. The second security amount is a second difference between the retail price of the first product and the purchase amount. The third security amount is a difference between the retail price of the first product and the third offer amount. In an embodiment, if the first product is damaged by any of the first through third users 102, 106, and 110, the transaction manager 214 may further authorize the issuer server 120 to deduct the corresponding security amount from one of the first through third payment accounts, respectively. In another embodiment, the issuer server 120 may block the first through third security amounts from the first through third payment accounts of the first through third users 102, 106, and 110, respectively, for the corresponding product usage duration only. For example, the issuer server 120 may block the first security amount on the first start date, the second security amount on the second start date, and the third security amount on the third start date based on the fifth request.

The issuer server 120 acknowledges the fifth request and deducts the first offer amount, the first purchase amount, and the third offer amount form the first through third payment accounts of the first through third users 102, 106, and 110, respectively. The issuer server 120 further blocks the first through third security amounts form the first through third payment accounts of the first through third users 102, 106, and 110, respectively. When the issuer server 120 blocks the first through third security amounts, the first through third security amounts are held unavailable for use from the first through third payment accounts, respectively.

The issuer server 120 further transmits a fifth notification to the transaction manager 214 indicating that first offer amount, the first purchase amount, and the third offer amount have been deducted, and the first through third security amounts have been blocked from the first through third payment accounts of the first through third users 102, 106, and 110, respectively. The first offer amount, the first purchase amount, and the third offer amount are credited to a merchant account of the merchant in the acquirer bank.

The product sharing manager 212 initiates the product sharing life-cycle when the first offer amount, the first purchase amount, and the third offer amount are credited to the merchant account. Based on the sequence included in the product sharing life-cycle, the merchant associated with the first merchant website 402 dispatches the first product to the second user 106. The merchant delivers the first product to the second user 106 on the second start date specified by the second user 106 in the corresponding one or more second time parameters. The merchant may use various product delivery services, such as a speed post services or courier services such as UPS®, FedEx®, DHL®, and the like, for delivering the first product to the second user 106.

The second user 106 uses the first product from the second start date to the second end date specified by the second user 106 in the corresponding one or more second time parameters. Thereafter, the merchant collects the first product form the second user 106 on the second end date. The issuer bank further releases the second security amount from the second payment account of the second user 106 at the second end date. The merchant further dispatches the first product to the first user 102, and delivers the first product to the first user 102 at the first start date. The first user 102 uses the first product from the first start date to the first end date. The merchant further collects the first product form the first user 102 at the first end date. The issuer bank further releases the first security amount from the first payment account of the first user 102 on the first end date. The merchant further dispatches the first product to the third user 110, and delivers the first product to the third user 110 at the third start date. The third user 110 uses the first product from the third start date to the third end date. Once the third user 110 finishes using the first product, the merchant collects the first product form the third user 110 on the third end date and returns it to the second user 106. The issuer bank further releases the third security amount from the third payment account of the third user 110 on the third end date.

In an eventuality that the first product is damaged or lost by any of the first, through third users 102, 106, and 110, one of the first through third security amounts are deducted from the first through third payment accounts, respectively. In one example, the first user 102 damages or loses the first product. The product sharing manager 212 transmits a sixth request to the issuer server 120 to deduct the first security amount from the first payment account of the first user 102. The transaction manager 214 further credits the first security amount to the merchant account of the merchant in the acquirer bank. In one embodiment, the merchant may dispatch a new first product to the third user 110, and deliver the new first product to the third user at the third start date. In another embodiment, the third offer amount may be rolled back to the third payment account from the merchant account, and the third security amount may be released for use from the third payment account.

It will be apparent to a person skilled in the art that the merchant server 114 can also facilitate sharing of the first product in a similar manner as described in the foregoing description, without deviating from the scope of the invention in any way.

Since each of the first offer amount, the purchase amount, and the third offer amount is less than the retail price of the third product, the first through third users 102, 106, and 110 pay less than the retail price of the first product. Further, the first through third users 102, 106, and 110 use the first product as per their requirements. The product sharing manager 212 charges the first offer amount, the purchase amount, and the third offer amount to the first through third users 102, 106, and 110, when the first and third users 102 and 110 confirm the product sharing life-cycle of the first product. This facilitates the first through third users 102, 106, and 110 to come to a consensus regarding the product sharing life-cycle of the first product. Hence, the first through third users 102, 106, and 110 do not have to wait till the first merchant website 402 offers a discounted price for purchasing or sharing the first product. Further, the product sharing life-cycle of the first product further facilitates the second user 106 to create the list of selected users based on his or her requirements. The transaction manager 214 transmits the fifth request to the issuer server 120 for deducting any one of the first through third security amounts if the first product gets damaged or lost during usage, which ensures that only one of the first through third users 102, 106, and 110 who is responsible for damaging or losing the first product pays the corresponding security amount. Hence, this provides a monetary benefit to the users who have not damaged the first product. Further, the merchant provides the first through third users 102, 106, and 110 with the new first product upon damage or loss. This is beneficial as the product sharing life-cycle is uninterrupted.

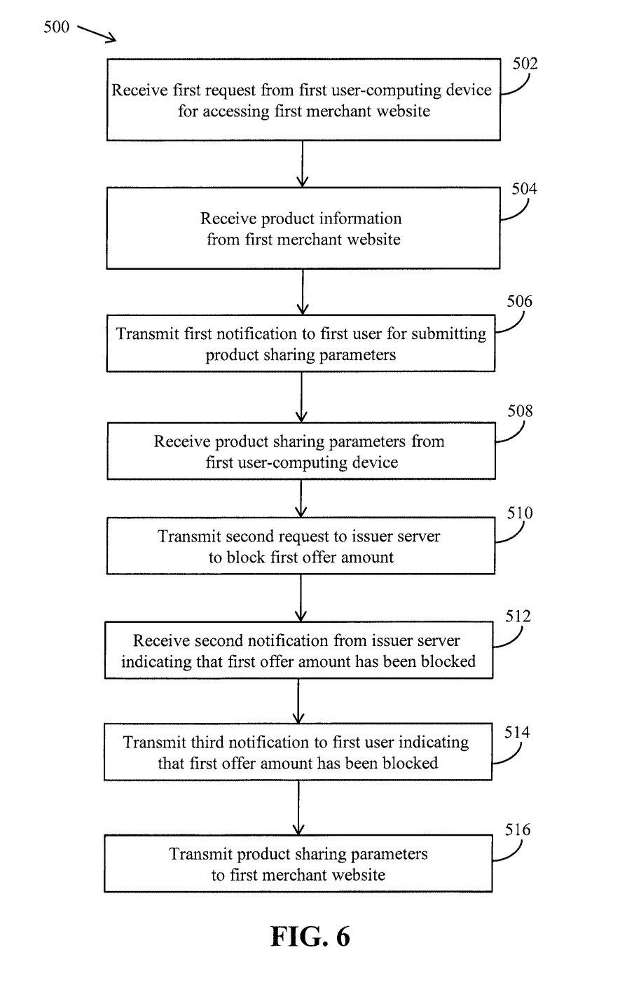

Referring now to FIG. 6, a high-level flowchart 500 that illustrates a method for selection of the first product by the first user 102 for sharing, in accordance with an embodiment of the present invention, is shown. The first user 102 logs into the first mobile application 124a by way of the first user-computing device 104. The first user 102 further selects the “Show interest in product” option 304 for sharing the first product on time-shared basis.

At step 502, the product sharing manager 212 receives the first request from the first user-computing device 104 for accessing the first merchant website 402, based on the selection of the option 304 performed by first user 102. The product sharing manager 212 further redirects the first mobile application 124a to the first merchant website 402 based on the first request. The first user 102 selects the first product from the catalogue of products displayed on the first merchant website 402 for sharing on a time-shared basis.

At step 504, the product sharing manager 212 receives the product information of the first product from the first merchant website 402. At step 506, the product sharing manager 212 transmits the first notification to the first user 102 to submit the product sharing parameters by way of the first mobile application 124a. Based on the first notification, the first user 102 further submits the product sharing parameters to the first mobile application 124a. At step 508, the product sharing manager 212 receives the product sharing parameters from the first user-computing device 104 by way of the first mobile application 124a.

At step 510, the transaction manager 214 transmits the second request to the issuer server 120 for blocking the first offer amount from the first payment account of the first user 102. At step 512, the transaction manager 214 receives the second notification from the issuer server 120 indicating that the first offer amount has been blocked from the first payment account of the first user 102.

At step 514, the transaction manager 214 transmits the third notification indicating that the first offer amount has been blocked from the first payment account to the first user-computing device 104. At step 516, the product sharing manager 212 further transmits the product sharing parameters to the first merchant website 402.

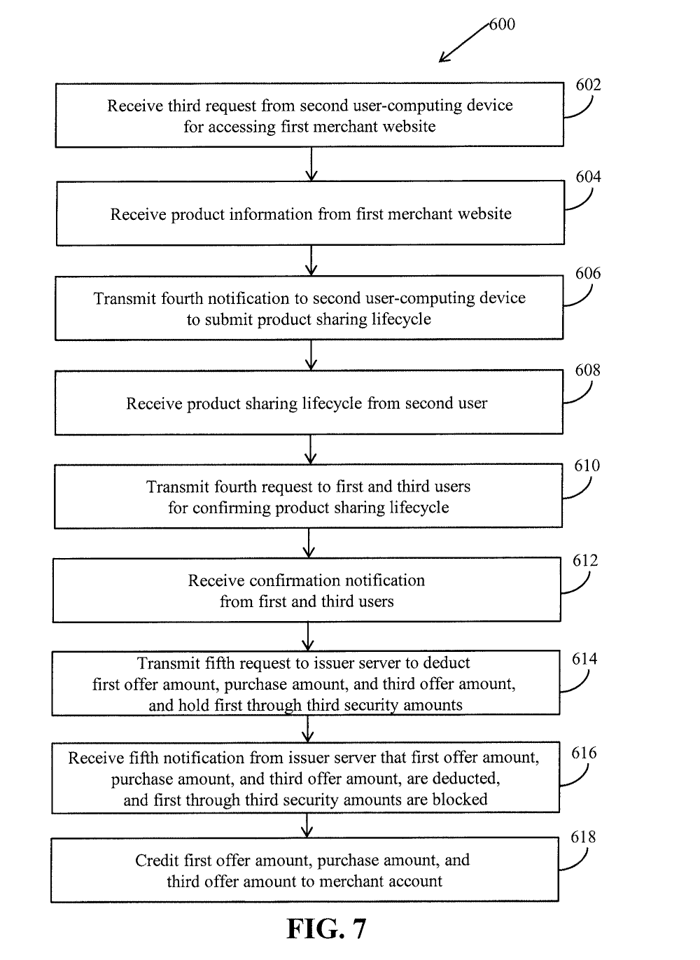

Referring now to FIG. 7, a high-level flowchart 600 that illustrates a method for sharing the first product among the plurality of users, such as the first through third users 102, 106, and 110, by using the first through third mobile applications 124a-124c of the communication environment 100 of FIG. 1, in accordance with an embodiment of the present invention, is shown. The second user 106 logs into the second mobile application 124b and further selects the “Purchase product on sharing” option 306 for purchasing and sharing the first product with the first and third users 102 and 110 on time-shared basis. At step 602, the product sharing manager 212 receives the third request for accessing the first merchant website 402 from the second user-computing device 108, based on the selection of the option 306 performed by the second user 106. The product sharing manager 212 further re-directs the second mobile application 124b to the first merchant website 402 based on the third request. The second user 106 selects the first product from the catalogue of products displayed on the first merchant website 402 to be purchased, and shared on time-shared basis.

At step 604, the product sharing manager 212 receives the product information of the first product from the first merchant website 402. At step 606, the product sharing manager 212 transmits the fourth notification to the second user-computing device 108 for defining the product sharing life-cycle.

At step 608, the product sharing manager 212 receives the product sharing life-cycle from the second user 106 by way of the second mobile application 124b. At step 610, the product sharing manager 212 further transmits the fourth request to the first and third user-computing devices 104 and 112 for confirming the product sharing life-cycle.

At step 612, the product sharing manager 212 receives the confirmation notification from the first and third users 102 and 110 by way of the first and third user-computing devices 104 and 112, respectively. The transaction manager 214 charges the first offer amount, the purchase amount, and the third offer amount from the first through third payment accounts of the first through third users 102, 106, and 110, respectively, based on the confirmation. At step 614, the transaction manager 214 transmits the fifth request to the issuer server 120 to deduct the first offer amount, the purchase amount, and the third offer amount, and block the first through third security amounts from the first through third payment accounts of the first through third users 102, 106, and 110, respectively. At step 616, the transaction manager 214 receives the fifth notification from the issuer server 120 indicating that the first offer amount, the purchase amount, and the third offer amount have been deducted, and the first through third security amounts have been blocked from the first through third payment accounts, respectively. At step 618, the transaction manager 214 credits the first offer amount, the purchase amount, and the third offer amount to the merchant account.

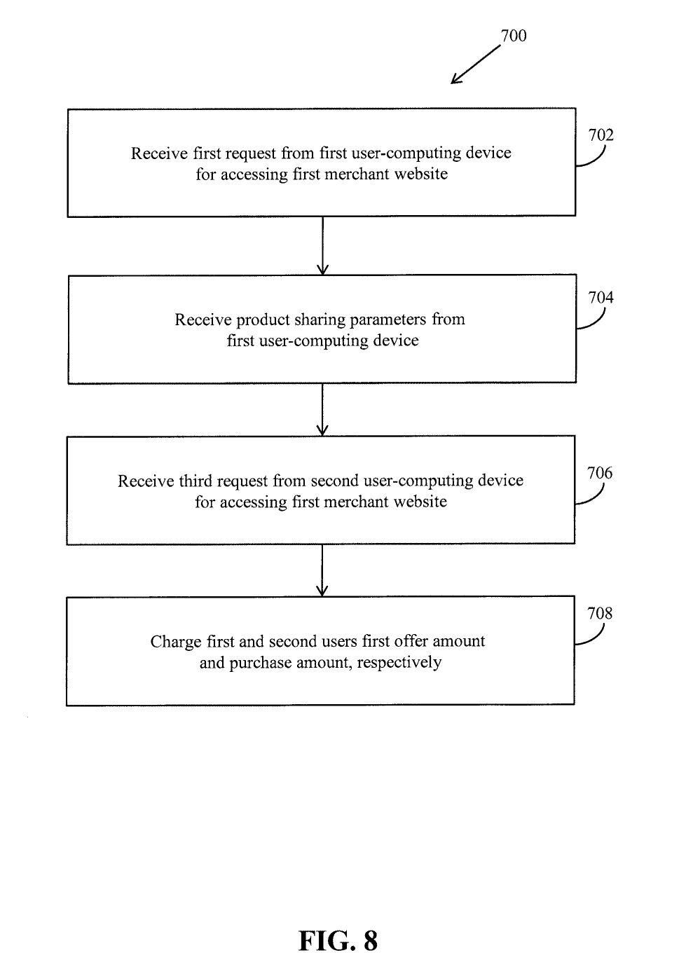

Referring now to FIG. 8, a flowchart 700 that illustrates a method for sharing a first product, listed for sale on the first merchant website 402, among the plurality of users, in accordance with an embodiment of the present invention, is shown. At step 702, the product sharing manager 212 receives the first request for accessing the first merchant website 402 from the first user-computing device 104 of the first user 102. The first user 102 accesses the first merchant website 402 to select the first product for sharing. At step 704, the product sharing manager 212 further receives the product sharing parameters submitted by the first user 102. The product sharing parameters include the first offer amount, and the one or more first time parameters for sharing the first product.

At step 706, the product sharing manager 212 receives the third request for accessing the first merchant website 402 from the second user-computing device 108 of the second user 106. The second user 106 accesses the first merchant website 402 to purchase the first product and further selects the first user 102 for sharing the first product on time-shared basis. At step 708, the transaction manager 214 charges the first and second users 102 and 106 the first offer amount and the purchase amount, respectively, for enabling sharing of the first product, when the first user 102 confirms the selection performed by the second user 106.

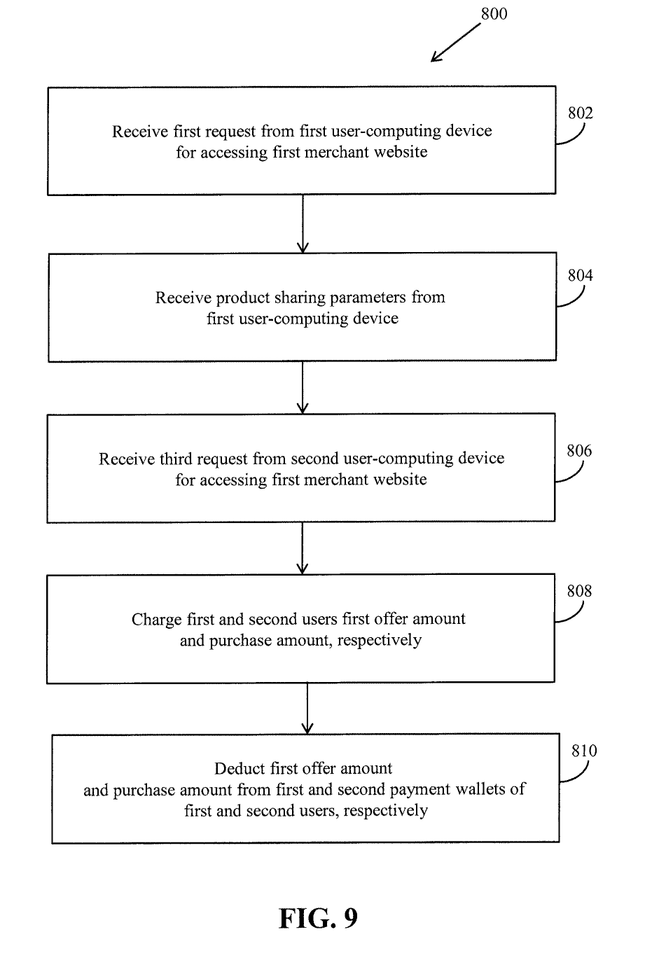

Referring now to FIG. 9, a flowchart 800 that illustrates a method for sharing a first product, listed for sale on the first merchant website 402, among the plurality of users, in accordance with another embodiment of the present invention, is shown. At step 802, the merchant server 114 receives the first request for accessing the first merchant website 402 from the first user-computing device 104 of the first user 102. The first user 102 accesses the first merchant website 402 to select the first product for sharing. At step 804, the merchant server 114 receives the product sharing parameters submitted by the first user 102. The product sharing parameters include the first offer amount, and the one or more first time parameters for sharing the first product. At step 806, the merchant server 114 receives the third request for accessing the first merchant website 402 from the second user-computing device 108 of the second user 106. The second user 106 accesses the first merchant website 402 to purchase the first product and further selects the first user 102 for sharing the first product on time-shared basis. At step 808, the merchant server 114 charges the first and second users 102 and 106 the first offer amount and the purchase amount, respectively, for enabling sharing of the first product, when the first user 102 confirms the selection performed by the second user 106. At step 810, the merchant server 114 deducts the first offer amount and the purchase amount from first and second payment wallets of the first and second users 102 and 106, respectively. The first and second payment wallets are maintained by the merchant server 114.

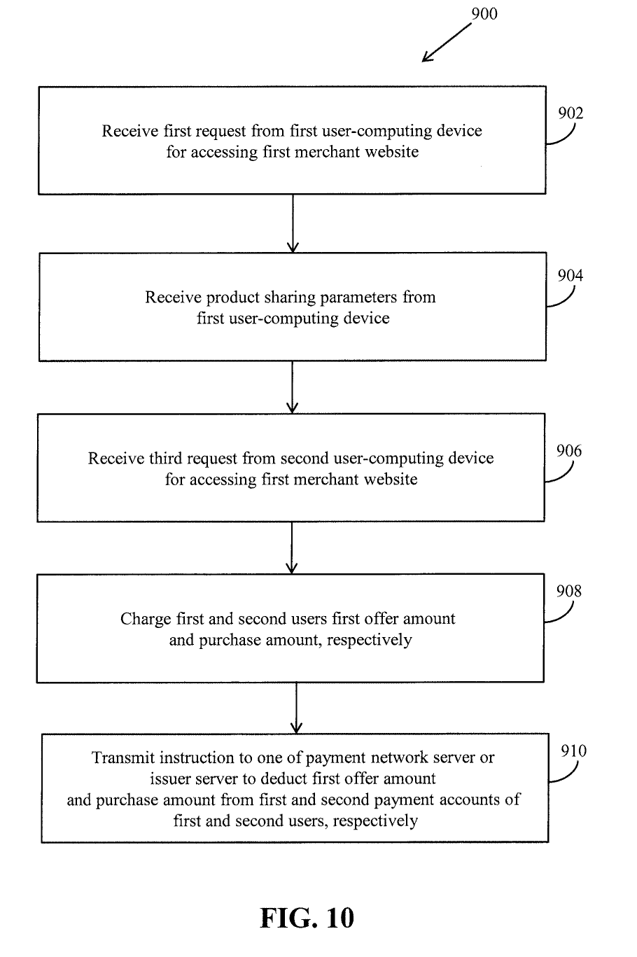

Referring now to FIG. 10, a flowchart 900 that illustrates a method for sharing a first product, listed for sale on the first merchant website 402, among the plurality of users, in accordance with another embodiment of the present invention, is shown. At step 902, the merchant server 114 receives the first request for accessing the first merchant website 402 from the first user-computing device 104 of the first user 102. The first user 102 accesses the first merchant website 402 to select the first product for sharing. At step 904, the merchant server 114 further receives the product sharing parameters submitted by the first user 102. At step 906, the merchant server 114 receives the third request for accessing the first merchant website 402 from the second user-computing device 108 of the second user 106. The second user 106 accesses the first merchant website 402 to purchase the first product and further selects the first user 102 for sharing the first product on time-shared basis. At step 908, the merchant server 114 charges the first and second users 102 and 106 the first offer amount and the purchase amount, respectively, for enabling sharing of the first product, when the first user 102 confirms the selection performed by the second user 106. At step 910, the merchant server 114 transmits an instruction to one of the payment network server 118 or the issuer server 120 to deduct the first offer amount and the purchase amount from the first and second payment accounts of the first and second users 102 and 106, respectively. Based on the instruction, the first offer amount and the purchase amount are deducted from the first and second payment accounts of the first and second users 102 and 106, respectively, and credited to the merchant account.

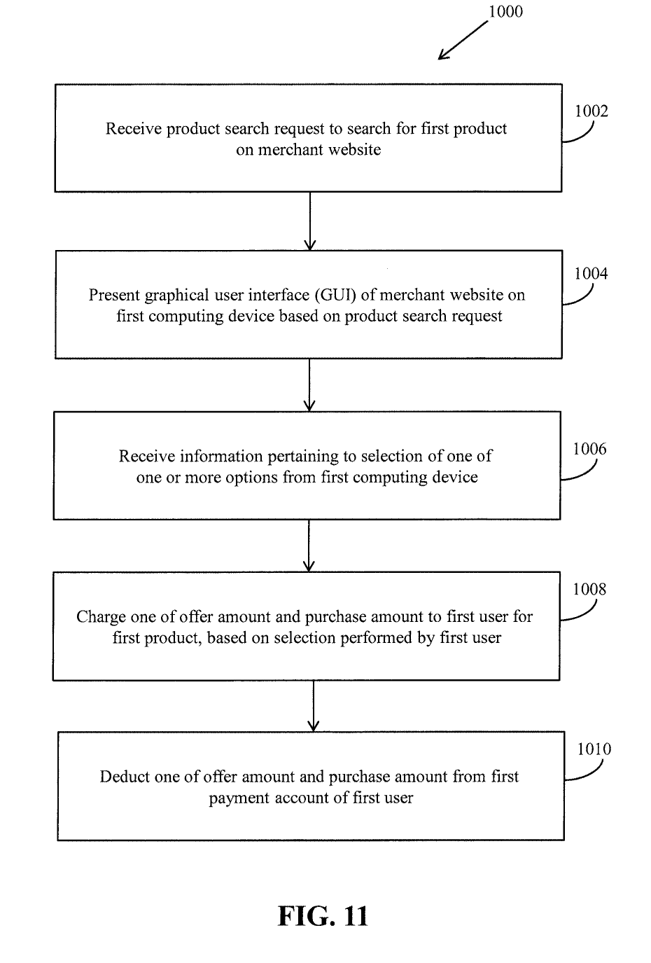

Referring now to FIG. 11, a flowchart 1000 that illustrates a method for sharing a first product, listed for sale on the first merchant website 402, among the plurality of users, in accordance with another embodiment of the present invention, is shown. At step 1002, the merchant server 114 receives a product search request from the first user-computing device 104 of the first user 102 to search for the first product on the merchant website 402. The first user 102 specifies the details of the first product, such as unique product identification number, a product name, and the like in the product search request. At step 1004, the merchant server 114 presents, a graphical user interface (GUI) of the merchant website 402 on the first computing device 104 based on the product search request. In one embodiment, the GUI of the merchant website 402 is similar to the first GUI 302. The GUI of the merchant website 402 displays the first product and one or more options associated with the first product. The one or more options include a first option that offers the first user 102 to share the first product with at least one second user 106 and a second option that offers the first user 102 to purchase the first product for sharing with at least one second user 106. In one example, the first and second options are similar to the “Show interest in product” option 304 and the “Purchase product on sharing” option 306 of the first GUI 302.

At step 1006, the merchant server 114 receives information pertaining to a selection of one of the one or more options from the first computing device 104. The first user 102 performs the selection. In one scenario, when the first user 102 wishes to use the first product without purchasing, the first user 102 selects the first option. In another scenario, when the first user 102 wishes to purchase the product and is also ready to share it with other users, such as the second and third users 106 and 110, the first user 102 selects the second option. At step 1008, the merchant server 114 charges one of the offer amount and the purchase amount to the first user 102 for the first product, based on the selection performed by the first user 102. In the scenario, when the first user 102 selects the first option, the merchant server 114 charges the offer amount specified by the first user 102 for the first product. In the scenario, when the first user 102 selects the second option, the merchant server 114 charges the purchase amount to the first user 102 for the first product. The purchase amount is less than the retail price of the first product. At step 1010, the merchant server 114 deducts one of the offer amount and the purchase amount from the first payment account, such as a first payment wallet, of the first user 102 and credits one of the offer amount and the purchase amount to the merchant account.

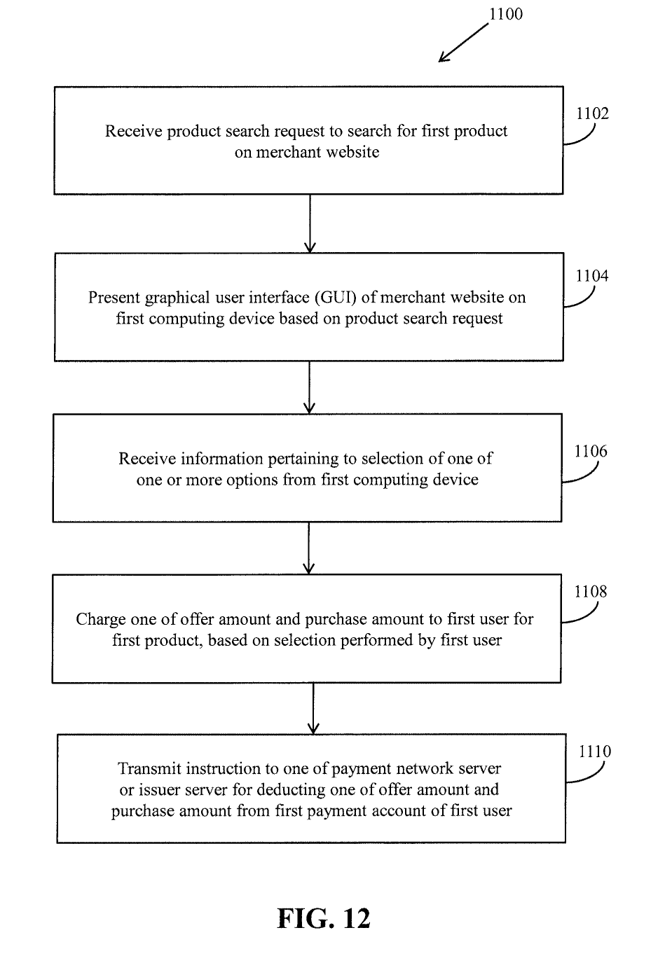

Referring now to FIG. 12, a high-level flowchart 1100 that illustrates a method for sharing a first product, listed for sale on the first merchant website 402, among the plurality of users, in accordance with another embodiment of the present invention, is shown. At step 1102, the merchant server 114 receives the product search request from the first user-computing device 104 of the first user 102 to search for the first product on the merchant website 402. At step 1104, the merchant server 114 presents the GUI of the merchant website 402 on the first computing device 104 based on the product search request. The GUI of the first merchant website 402 displays the first product and the one or more options associated with the first product. The one or more options include the first and second options as explained in FIG. 1000. At step 1106, the merchant server 114 receives the information pertaining to a selection of one of the one or more options from the first computing device 104. The first user 102 performs the selection. At step 1108, the merchant server 114 charges one of the offer amount and the purchase amount to the first user 102 for the first product, based on the selection performed by the first user 102 as explained in FIG. 1000. At step 1110, the merchant server 114 transmits an instruction to one of the payment network server 118 or the issuer server 120 for deducting one of the offer amount and the purchase amount from the first payment account of the first user 102. The payment network server 118 or the issuer server 120 deducts one of the offer amount and the purchase amount from the first payment account of the first user 102 and credits to the merchant account.

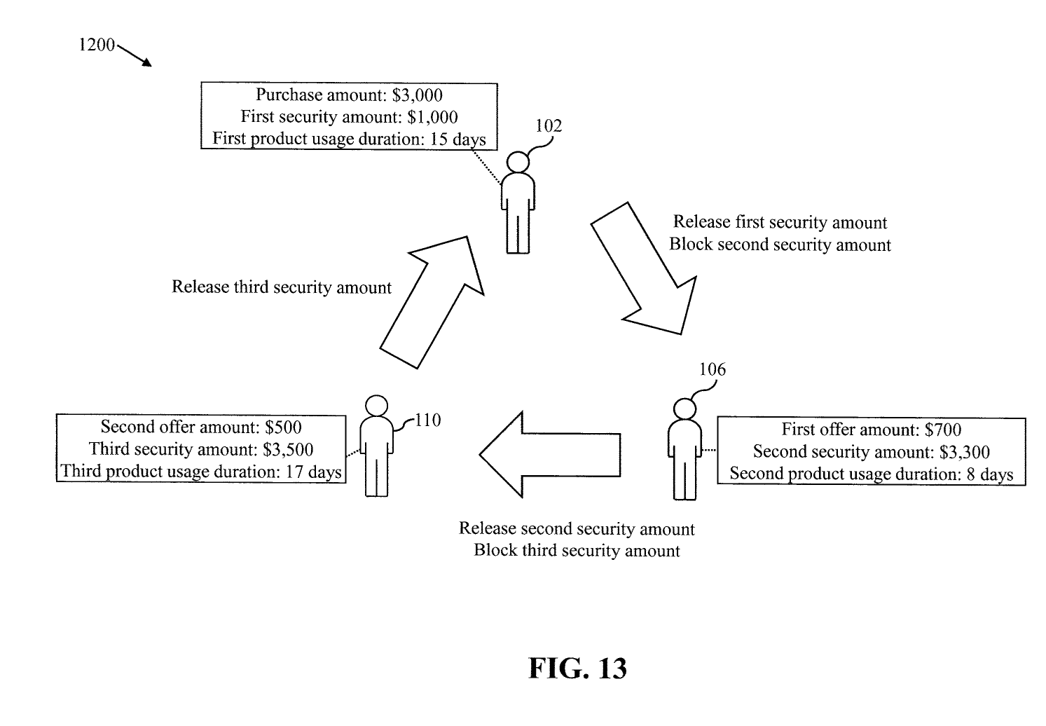

Referring now to FIG. 13, a block diagram that illustrates a product sharing life-cycle 1200 for sharing the first product among the plurality of users, in accordance with an embodiment of the present invention, is shown.

With reference to the product sharing life-cycle 1200, the first user 102 purchases the first product from the first merchant website 402 on sharing basis. The retail price of the first product as listed on the first merchant website 402 is USD 4,000. Since the second and third users 106 and 110 have selected the first product for sharing, and have specified the first and second offer amounts as USD 700 and USD 500, the purchase amount as listed on the first merchant website 402 is USD 3,000, which is less than the retail price. When the first user 102 purchases the first product, the issuer server 120 blocks the first security amount USD 1,000, which is a difference of the purchase amount USD 3,000 and the retail price USD 4,000, from the first payment account of the first user 102. Further, the issuer server 120 deducts the purchase amount USD 3,000, the first and second offer amounts USD 700 and USD 500 from the first through third payment accounts of the first through third users 102, 106, and 110, respectively, and credits to the merchant account.

The first user 102 uses the first product for the first product duration, i.e., 15 days. After the first product duration elapses, the first product is collected from the first user 102 and delivered to the second user 106, who is listed next to the first user 102 for using the first product in the product sharing life-cycle 1200. When the first product is collected from the first user 102, the issuer server 120 releases the first security amount USD 1,000 from the first payment account. The issuer server 120 further blocks the second security USD 3,300, which is a difference of the first offer amount USD 700 and the retail price USD 4,000, from the second payment account of the second user 106. The second user 106 uses the first product for the second product duration, i.e., 8 days. After the second product duration elapses, the first product is collected from the second user 106 and delivered to the third user 110, who is listed next to the second user 106 for using the first product in the product sharing life-cycle 1200. When the first product is collected from the second user 106, the issuer server 120 releases the second security amount USD 3,300 from the second payment account. The issuer server 120 further blocks the third security USD 3,500, which is a difference of the second offer amount USD 500 and the retail price USD 4,000, from the third payment account of the third user 110.

The third user 110 uses the first product for the third product duration, i.e., 17 days. After the third product duration elapses, the first product is collected from the third user 110 and delivered back to the first user 102, who is the actual owner of the first product. When the first product is collected from the third user 110, the issuer server 120 releases the third security amount USD 3,500 from the third payment account. When the first user 102 receives the first product from the third user 110, the product sharing life-cycle 1200 ends.

The merchant earns a total of USD 4,200 for the first product which has the retail price of USD 4,000. By implementing the sharing of the first product among the plurality of users, such as the first through third users 102, 106, and the 110, the merchant has an additional profit of USD 200 in comparison with its retail price, which was USD 4,000. The first through third users 102, 106, and 110 use the first product without actually paying the retail price of the first product. Hence, the method for sharing products among the plurality of users is economically beneficial to both the merchant and the plurality of users.

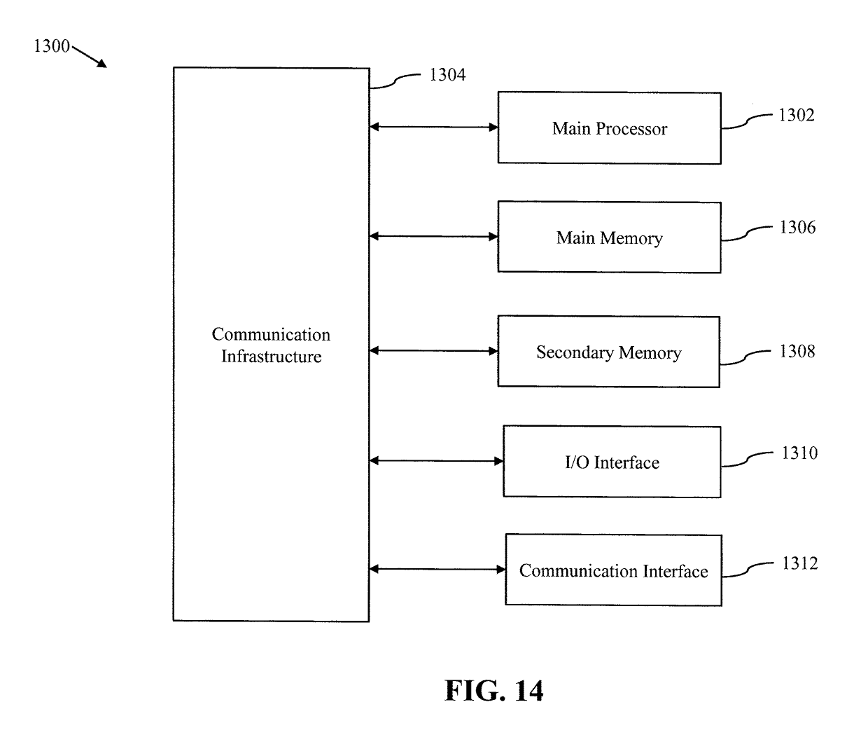

Referring now to FIG. 14, a block diagram that illustrates system architecture of a computer system 1300, in accordance with an embodiment of the present invention, is shown. An embodiment of present invention, or portions thereof, may be implemented as computer readable code on the computer system 1300. In one example, the first through third user-computing devices 104, 108, and 112, the merchant server 114, the acquirer server 116, the payment network server 118, and the issuer server 120 of FIG. 1 may be implemented in the computer system 1300 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 6-12.

The computer system 1300 includes a main processor 1302 that may be a special purpose or a general-purpose processing device. The main processor 1302 may be a single processor, multiple processors, or combinations thereof. The main processor 1302 may have one or more processor “cores.” In one example, the main processor 1302 is an octa-core processor. Further, the main processor 1302 may be connected to a communication infrastructure 1304, such as a bus, message queue, the bus 208, multi-core message-passing scheme, and the like. The computer system 1300 further includes a main memory 1306 and a secondary memory 1308. Examples of the main memory 1306 may include RAM, ROM, dynamic RAM (DRAM), and the like. The secondary memory 1308 may include a hard disk drive or a removable storage drive, such as a floppy disk drive, a magnetic tape drive, a compact disc, an optical disk drive, a flash memory, and the like. Further, the removable storage drive may read from and/or write to a removable storage device in a manner known in the art. In one example, if the removable storage drive is a compact disc drive, the removable storage device may be a compact disc. In an embodiment, the removable storage unit may be a non-transitory computer readable recording media.

The computer system 1300 further includes an input/output (I/O) interface 1310 and a communication interface 1312. The I/O interface 1310 includes various input and output devices that are configured to communicate with the main processor 1302. Examples of the input devices may include a keyboard, a mouse, a joystick, a touchscreen, a microphone, and the like. Examples, of the output devices may include a display screen, a speaker, headphones, and the like. The communication interface 1312 may allow data to be transferred between the computer system 1300 and various devices that are communicatively coupled to the computer system 1300. Exemplary communication interfaces 1312 may include a modem, a network interface, i.e., an Ethernet card, a communications port, and the like. Data transferred via the communication interface 1312 corresponds to signals, such as electronic, electromagnetic, optical, or other signals as will be apparent to a person skilled in the art. The signals may travel via a communications channel (not shown) which transmits the signals to devices that are communicatively coupled to the computer system 1300. Examples of the communications channel include, but are not limited to, cable, fiber optics, a phone line, a cellular phone link, or a radio frequency link.

Computer program medium and computer usable medium may refer to a non-transitory computer readable medium, such as the main memory 1306 and the secondary memory 1308, which may be a semiconductor memory such as a DRAM. The computer program medium may provide data that enables the computer system 1300 to implement the methods illustrated in FIGS. 6-12. In an embodiment, the present invention is implemented using a computer implemented application, the computer implemented application may be stored in a computer program product and loaded into the computer system 1300 using the removable storage drive or the hard disc drive in the secondary memory 1308, the I/O interface 1310, or the communication interface 1312.

A person having ordinary skill in the art will appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor such as the main processor 1302 and a memory such as the main memory 1306 and the secondary memory 1308 implements the above described embodiments. Further, the operations may be described as a sequential process, however some of the operations may in fact be performed in parallel, concurrently, and/or in a distributed environment, and with program code stored locally or remotely for access by single or multiprocessor machines. In addition, in some embodiments the order of operations may be rearranged without departing from the spirit of the disclosed subject matter.

Techniques consistent with the present invention provide, among other features, systems and methods for facilitating sharing of a product among a plurality of users. While various exemplary embodiments of the disclosed system and method have been described above it should be understood that they have been presented for purposes of example only, not limitations. It is not exhaustive and does not limit the invention to the precise form disclosed.

In the claims, the words ‘comprising’, ‘including’ and ‘having’ do not exclude the presence of other elements or steps then those listed in a claim. The terms “a” or “an,” as used herein, are defined as one or more than one. Unless stated otherwise, terms such as “first” and “second” are used to arbitrarily distinguish between the elements such terms describe. Thus, these terms are not necessarily intended to indicate temporal or other prioritization of such elements. The fact that certain measures are recited in mutually different claims does not indicate that a combination of these measures cannot be used to advantage.

While various embodiments of the present invention have been illustrated and described, it will be clear that the present invention is not limited to these embodiments only. Numerous modifications, changes, variations, substitutions, and equivalents will be apparent to those skilled in the art, without departing from the spirit and scope of the present invention, as described in the claims.

What is claimed is:

1. A method for facilitating sharing of a product among a plurality of users, the method comprising:
receiving, by a server, a first request for accessing a merchant website from a first computing device of a first user, wherein the first user accesses the merchant website to select a first product for sharing;
receiving, by the server, one or more product sharing parameters submitted by the first user, wherein the one or more product sharing parameters include a first offer amount, and one or more time parameters for sharing the first product;
receiving, by the server, a second request for accessing the merchant website from a second computing device of a second user, wherein the second user accesses the merchant website to purchase the first product, and wherein the second user selects the first user to share the first product with, on time-shared basis; and
charging, by the server, the first and second users the first offer amount and a purchase amount, respectively, when the first user confirms the selection performed by the second user.

2. The method of claim 1, further comprising redirecting, by the server, the first and second computing devices to the merchant website from first and second mobile applications, respectively, based on the first and second requests, respectively.

3. The method of claim 1, further comprising receiving, by the server, product information of the first product from the merchant website, when the first user selects the first product for sharing, wherein the product information includes at least one of an identification number, a name, and a retail price of the first product.

4. The method of claim 1, further comprising receiving, by the server, account identification information of the first and second users from the first and second computing devices, based on the first and second requests, respectively.

5. The method of claim 4, further comprising verifying, by the server, the account identification information of the first and second users for sharing the first product.

6. The method of claim 1, further comprising transmitting, by the server, a list of users that have selected the first product for sharing on the time-shared basis to the second computing device of the second user, wherein the second user selects the first user from the list of users to share the first product with on the time-shared basis.

7. The method of claim 1, further comprising communicating, by the server, a third request to the first user by way of the first computing device to confirm the selection performed by the second user.

8. The method of claim 7, further comprising receiving, by the server, a confirmation notification in response to the third request from the first computing device, wherein the confirmation notification indicates one of a confirmation and a rejection of the selection performed by the second user.

9. The method of claim 1, wherein the first offer amount and the purchase amount are debited from first and second payment accounts of the first and second users, respectively.

10. The method of claim 9, further comprising transmitting, by the server, a fourth request to an issuer server to block first and second security amounts from the first and second payment accounts on a first start date and a second start date, respectively, wherein the first security amount is a first difference of a retail price of the first product and the first offer amount, and wherein the second security amount is a second difference of the retail price of the first product and the purchase amount.

11. The method of claim 10, wherein the issuer server releases the first and second security amounts from the first and second payment accounts on first and second end dates, respectively, wherein the one or more time parameters include the first start date and the first end date, and wherein the second user uses the first product from the second start date to the second end date.

12. A system for sharing a product among a plurality of users, the system comprising:
a memory; and
a processor that communicates with the memory, wherein the processor is configured to:
receive a first request for accessing a merchant website from a first computing device of a first user, wherein the first user accesses the merchant website to select a first product for sharing;
receive one or more product sharing parameters submitted by the first user, wherein the one or more product sharing parameters include a first offer amount, and one or more time parameters for sharing the first product;
receive a second request for accessing the merchant website from a second computing device of a second user, wherein the second user accesses the merchant website to purchase the first product, and wherein the second user selects the first user to share the first product on time-shared basis; and
charge the first and second users the first offer amount and a purchase amount, respectively, to enable sharing of the first product between the first and second users, when the first user confirms the selection performed by the second user.

13. The system of claim 12, wherein the processor redirects the first and second computing devices to the merchant website from first and second mobile applications installed on the first and second computing devices based on the first and second requests, respectively.

14. The system of claim 12, wherein the processor receives account identification information of the first and second users from the first and second computing devices, based on the first and second requests, respectively, and wherein the processor verifies the account identification information of the first and second users for sharing the first product.

15. The system of claim 12, wherein the processor transmits a list of users that have selected the first product for sharing on the time-shared basis to the second computing device of the second user, and wherein the second user selects the first user from the list of users to share the first product with on the time-shared basis.

16. The system of claim 12, wherein the processor communicates a third request to the first user by way of the first computing device to confirm the selection performed by the second user.

17. The system of claim 12, wherein the processor receives a confirmation notification in response to the third request from the first computing device, and wherein the confirmation notification indicates one of a confirmation and a rejection of the selection performed by the second user.

18. A method for facilitating sharing of a product among a plurality of users, the method comprising:
receiving, by a merchant server, a product search request from a first computing device of a first user to search for a first product on a merchant website;
presenting, by the merchant server, a graphical user interface (GUI) of the merchant website on the first computing device based on the product search request, wherein the GUI displays the first product and one or more options associated with the first product, and wherein the one or more options include a first option that offers the first user to share the first product with at least one second user and a second option that offers the first user to purchase the first product for sharing with at least one second user;
receiving, by the merchant server, information pertaining to a selection of one of the one or more options from the first computing device, wherein the first user performs the selection; and
charging, by the merchant server, one of an offer amount and a purchase amount to the first user for the first product, based on the selection performed by the first user.

19. The method of claim 18, further comprising deducting, by the merchant server, one of the offer amount and the purchase amount from a first payment account of the first user.

20. The method of claim 18, further comprising transmitting, by the merchant server, a second request to a payment network server, for deducting one of the offer amount and the purchase amount from a first payment account of the first user, wherein the payment network server deducts one of the offer amount and the purchase amount from the first payment account.
